(19) United States
(12) Patent Application Publication
(10) Pub. No.: US 2008/0169439 A1
(43) Pub. Date: Jul. 17, 2008

(54) Integrated two-stage low-leak control valve

(75) Inventors: Jeffrey J. Waterstredt, Royal Oak, MI (US); Garrett R. Holmes, Ortonville, MI (US); Steven L. Ambrose, White Lake, MI (US); Daniel L. DeLand, Davison, MI (US)

Correspondence Address: WARN, HOFFMANN, MILLER & OZGA, P.C., P.O. BOX 70098, ROCHESTER HILLS, MI, 48307, US

(73) Assignee: BorgWarner Inc., Auburn Hills, MI (US)

(21) Appl. No.: 12/002,606

(22) Filed: Dec. 18, 2007

Related U.S. Application Data
(60) Provisional application No. 60/875,482, filed on Dec. 18, 2006.

(51) Int. Cl. F16K 31/12

(52) U.S. Cl. 251/29

(57) ABSTRACT

The present invention is an integrated two-stage low-leak control valve which is used to control pressure or flow in a hydraulic system such as an automatic transmission valve body. The control valve formed of a single assembly. A valve portion and a solenoid portion are located in the single assembly. The solenoid portion is operably connected to the valve portion with two variable orifices contained in the single assembly. A first variable orifice controls the flow of a fluid medium from a supply port in the integrated control valve to a pressure control region of the integrated control valve, and a second variable orifice controls the flow of the fluid medium to an exhaust port in the integrated control valve.

### CROSS-REFERENCE TO RELATED APPLICATIONS

This application claims the benefit of U.S. Provisional Application No. 60/875,482, filed Dec. 18, 2006.

### FIELD OF THE INVENTION

The present invention relates to high-flow hydraulic control valves and electro-hydraulic solenoid valves used for pilot control of high-flow hydraulic control valves.

### BACKGROUND OF THE INVENTION

Hydraulic control valves are used in various applications to control fluid flow and pressure in a hydraulic system such as an automatic transmission. In many cases, pilot pressure is supplied to the electro-hydraulic solenoid valve in order to control the valve. In many recent applications, a closed-end or low-leak bleed solenoid is the preferred pilot control device due to its desirable leakage characteristics and competitive cost. In all known existing applications, the low-leak solenoid and the high-flow control valve are two separate components eventually integrated in a transmission valve body. Combining the solenoid and spool portions into the same housing would provide many advantages over existing designs.

Accordingly, there exists a need for the integration of a low-leak bleed solenoid and a spool valve to provide the benefits of having both devices provided as one single component.

### SUMMARY OF THE INVENTION

The present invention is an integrated two-stage low-leak control valve which can be used to control pressure or flow as a function of current. The control valve is formed of a single assembly. A valve portion and a solenoid portion are located in the integrated control valve. The solenoid portion is operably connected to the valve portion with two variable orifices contained in the integrated control valve. A first variable orifice controls the flow of a fluid medium from a supply port in the integrated control valve to a pilot pressure control region of the integrated control valve and a second variable orifice controls the flow of the fluid medium to an exhaust port in the integrated control valve.

The valve portion has a control port that is metered to both a supply port and an exhaust port. Pilot pressure form the solenoid portion is used to control the valve portion and is balanced against a feedback pressure from the control port, a spool spring or a combination of the two.

A pump and a regulator valve can be connected to the supply port, as well as a second limit valve. Exhaust from the second variable orifice as well as the valve portion enters a fluid reservoir.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic showing a spool valve incorporated with a regulator valve into a single assembly, with a fluid conduit for delivering fluid to the spool valve located outside the housing, according to the present invention;

FIG. 2 is schematic of an alternate embodiment of the present invention, with the fluid conduit located inside the single assembly;

FIG. 3 is a schematic of another embodiment of the present invention, with the addition of a secondary limit valve;

FIG. 4 is a schematic of still another alternate embodiment of the present invention with the spool valve being used to actuate a shift fork; and

FIG. 5 is an example of the physical embodiment of the schematic in FIG. 1.

### DETAILED DESCRIPTION OF THE PREFERRED EMBODIMENTS

The following description of the preferred embodiment(s) is merely exemplary in nature and is in no way intended to limit the invention, its application, or uses.

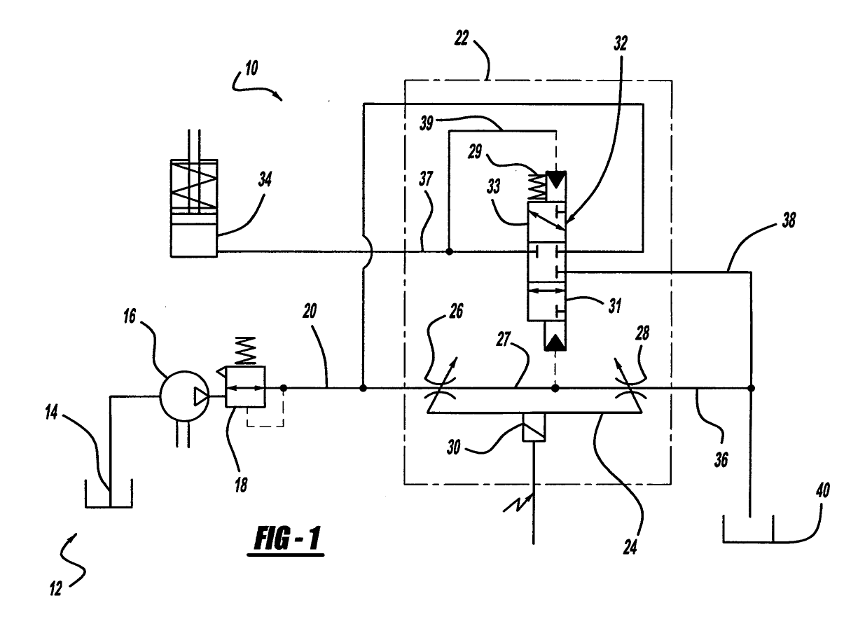

Referring to FIG. 1, a schematic showing a hydraulic system including an integrated two-stage low-leak control valve according to the present invention is shown generally at 10. The hydraulic system 10 has a fluid reservoir 12 which contains a fluid medium 14. A hydraulic pump 16 is connected to the reservoir 12 and to a regulator valve 18. The regulator valve is connected to a supply port 20 which feeds into an integrated control valve 22. The integrated control valve 22 has a low-leak pilot bleed valve 24 which includes a first variable orifice 26 and a second variable orifice 28. The low-leak pilot bleed valve controls the pilot pressure 27 between the two orifices. The bleed valve 24 is controlled by a solenoid portion 30, and is operably connected to an integrated flow amplifier or spool 32. The spool 32 is connected to and used to actuate an actuator or hydraulic clutch 34 by way of a control port 37. The hydraulic clutch 34 may be replaced by another type of device requiring fluid pressure to be actuated such as a shift fork, or other similar actuator. The second variable orifice 28 is connected to a first pressure exhaust 36. There is also a second pressure exhaust 38 connected to the spool 32. The first pressure exhaust 36 and the second pressure exhaust 38 both are connected to a common drain reservoir 40 or sump.

In operation, the fluid reservoir 12 contains a fluid medium 14 which is pumped through the regulator valve 18 by the hydraulic pump 16. The fluid medium 14 then flows into the integrated control valve 22 via the supply port 20. When the solenoid portion 30 is actuated to close first variable orifice 26, second variable orifice 28 will be open. The pilot pressure 27 is decreased in this way. As the pilot pressure decreases, the spool 32 becomes unbalanced and moves toward an exhaust position 33. Pressure in the control port therefore decreases and this is communicated via the control feed back passage 39 to the side of the spool 32 opposite the side the pilot pressure 27 is acting. When the pressure at the control feedback passage 39 and the force of the spool spring 29 balance against the pilot pressure 27, the spool 32 stops moving and the pressure in the control port 37 stabilizes.

When the solenoid portion 30 is actuated to open the first variable orifice 26, the second variable orifice 28 will be closed. The pilot pressure 27 is increased in this way. As the pilot pressure increases, the spool 32 becomes unbalanced and moves toward its supplied position 31. Pressure in the control port therefore increases and this is communicated via the control feedback passage 39 to the side of the spool 32 opposite the side the pilot pressure 27 is acting. When the pressure at the control feedback passage 39 and the force of the spool spring 29 balance against the pilot pressure 27, the spool 32 stops moving and the pressure in the control port 37 stabilizes.

It is further within the scope of this invention that the bleed valve 24 can regulate the pilot pressure 27 as a function of the current supplied to the solenoid 30. The pilot pressure 27 acts on a feedback area of the bleed valve 24, which is not shown in the schematic, to provide variable pressure output. The spool 32 is also able to provide variable pressure output to the control port 37 as a function of the pilot pressure 27 upon which it is acted.

Integrating the bleed valve 24 and the spool valve 32 into a single assembly allows for the combined electronic characterization of the integrated control valve 22 as a system. In this way, performance variation of the solenoid 30, bleed valve 24, spool 32 and spring 29 are considered together and zeroed out electronically to minimize pressure error or variation to the hydraulic clutch 34. Furthermore, this can be done as a subassembly eliminating the need to do the characterization to the transmission valve body. Integration in this fashion also improves packaging considerations and serviceability.

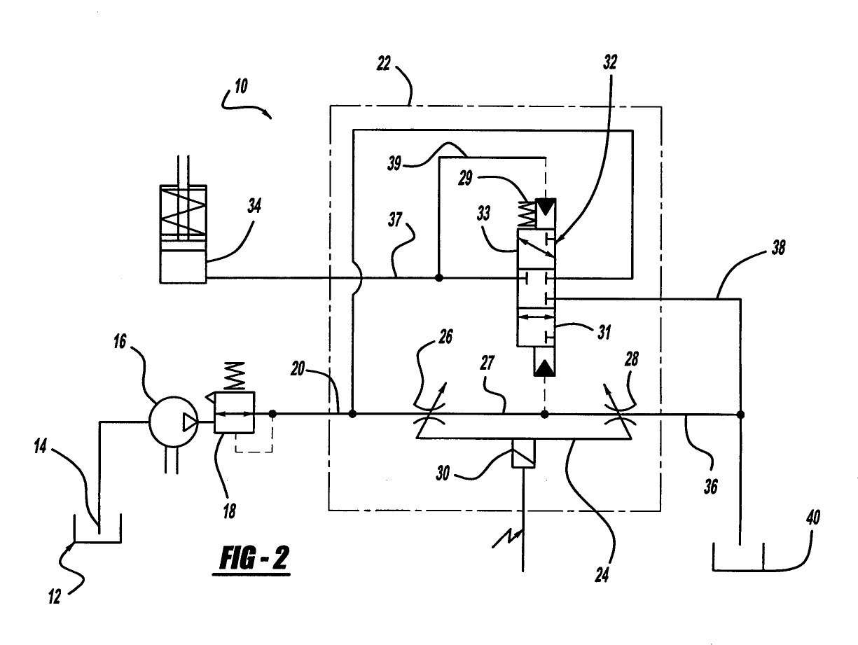

FIG. 2 shows an alternate embodiment of the present invention in which the supply port 20 is split to feed the bleed valve 24 and the spool 32 within the integrated control valve 22.

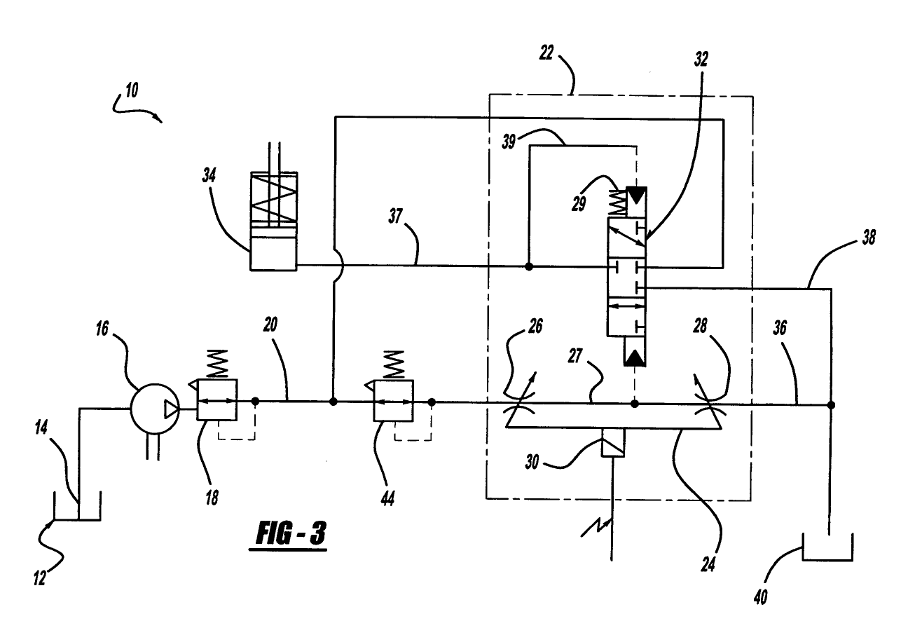

Another alternate embodiment is shown in FIG. 3. This embodiment is similar to the embodiment shown in FIG. 1, with the exception that a secondary limit valve 44 has been added between the supply port 20 and the regulator valve 18 for the purpose of feeding the bleed valve 24 with reduced pressure.

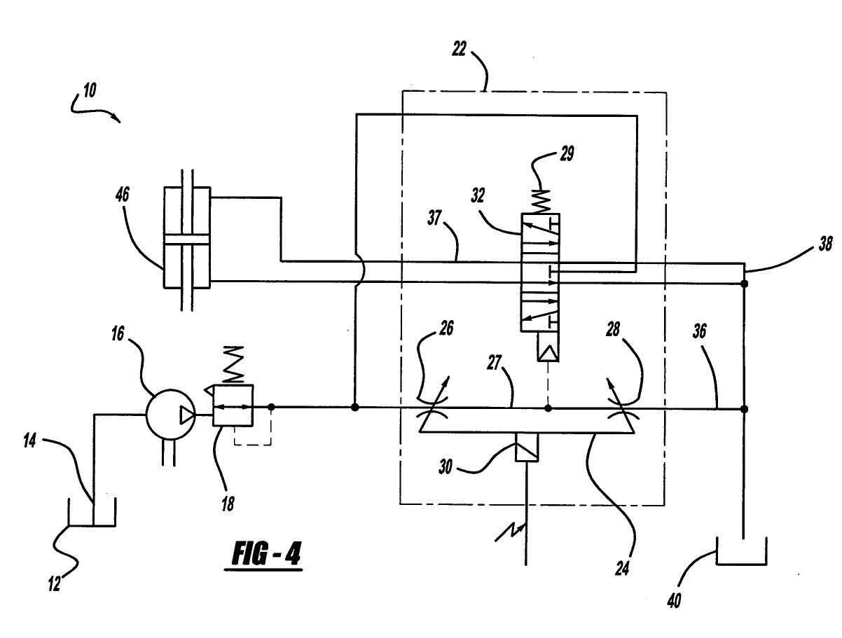

Still another alternate embodiment is shown in FIG. 4; in this embodiment, the integrated control valve 22 is used to actuate a shift fork 46. In this case, the spool 32 is a 3-position, sport valve, but other spool configurations are possible and obvious.

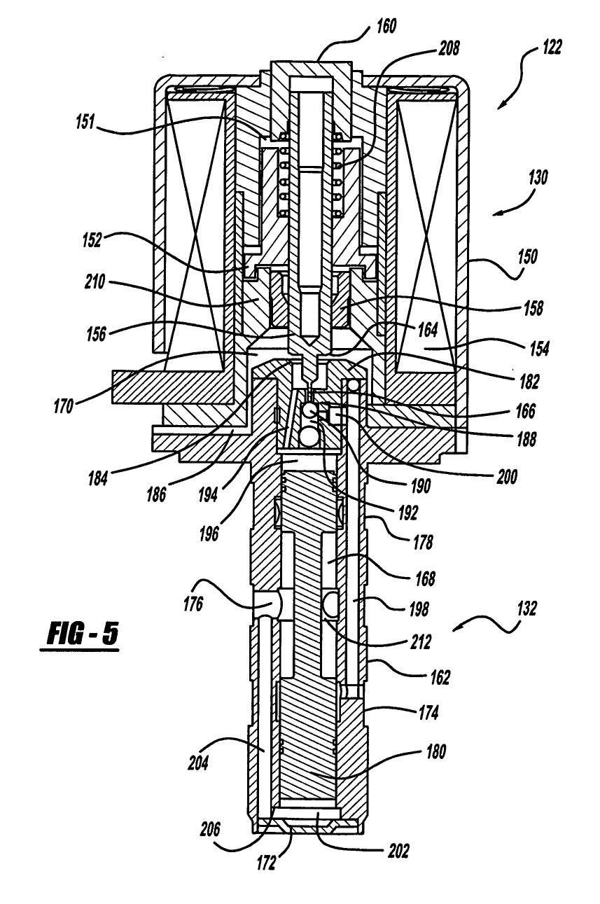

FIG. 5 is a cross-sectional plan view of the integrated two-stage low-leak control valve 122 in a normally-low pressure configuration. The valve depicted in FIG. 5 is merely exemplary as there are many ways to design a valve with all the features shown in FIGS. 1-4. When the two-stage proportional bleed valve is the normally-low pressure configuration this means that when a solenoid portion 130 is de-energized a spool 180 is moved to such a position that a control port 176 is closed; therefore, the pressure at the control port 176 is at or near zero. When the valve is in a normally-high configuration the components of the valve are arranged so that when the solenoid portion 130 is de-energized the spool 180 is placed in a position where the control port 176 is in the open position and high pressure is moving through the control port 176.

The integrated control valve 122 has a solenoid portion 130 with a housing 150. Within the housing 150 is a coil 154 for conducting magnetic flux when energized. An armature 152 is slidably disposed within a solenoid bore 151 of the housing 150. The armature 152 will slide through the longitudinal axis of the solenoid bore 151 in response to the energization of the magnetic coil 154.

A pin valve 156 is press fit on the armature 152 and extends longitudinally through the solenoid bore 151. The pin valve 156 is supported by a front bearing 158 and a rear bearing 160. The pin valve 156 extends from the solenoid portion 130 partially into a valve housing 162 where the pin valve 156 has an annular shoulder 164 and a tappet 166.

The valve housing 150 is the portion of the bleed valve 122 that controls the passage of fluid through the bleed valve 122. The valve housing 162 has a longitudinal bore 168 having a first end 170 located adjacent the solenoid 130, and a second end 172 located at an end of the valve housing 162 distal from the solenoid 130, and a second end 172 located at an end of the valve housing 162 distal from the solenoid 130. The valve housing 162 has a supply port 174 for supplying fluid media to the integrated control valve 122 from a pressurized source. A control port 176 is also connected to the valve housing 162 and is used to apply pressurized fluid from the valve housing 162 to the hydraulic clutch 134. Additionally, there is an exhaust port 178 connected to the valve housing 162 that directs pressurized fluid back to a sump when the supply port 174 is closed.

In order to facilitate the opening and closing of the supply port 174, control port 176 and exhaust port 178, a spool is slidably disposed within the longitudinal bore 168 of the valve housing 162. The spool 180 has a reduced diameter portion. In this particular embodiment of the invention the spool 180 has a reduced diameter portion. In this particular embodiment of the invention the spool 180 is shown as an open center spool, but it is within the scope of the invention to use a closed center spool.

A pilot control member 182 is located at the first end 170 of the longitudinal bore 168 between the spool 180 and solenoid 130. The pilot control member 182 has a pilot exhaust valve seat 184 that is in close proximity with the annular shoulder 164 of the pin valve 156. As the pin valve 156 moves in a downward direction (relative to FIG. 5) the annular shoulder 164 moves toward the pilot exhaust valve seat 184 to adjust the flow of fluid through the pilot exhaust valve seat 184. As fluid moves past the pilot exhaust valve seat 184 it flows to an exhaust pilot port 186 extending through the valve housing 162. The pilot exhaust valve seat 184 and annular shoulder 164 can both have tapered surfaces that help enhance the throttling action of fluid as it moves past the pilot exhaust valve seat 184.

The pilot control member 182 also has a low-leak bleed valve shown generally at 188. The low-leak bleed valve 188 consists of the tappet 66 of the pin valve 156 and a ball 190 that is contained within a cage 192. The low-leak bleed valve 188 can be opened and closed when the tapped 166 presses the ball 190 downward away from the edge of the cage 192.

The pilot control member 182 also has a pilot passage 194 extending between the low-leak bleed valve 188 to a pilot control chamber 196 that is defined as a portion of the longitudinal bore 168 between the pilot control member 182 and the spool 180. The pilot passage 194 and pilot control chamber 196 allow pressurized fluid from the supply port 174 to flow into the pilot control chamber 196 and move the spool 180 downward relative to FIG. 5 so that pressure from the supply port 174 enters the pressure transition region 212 and flows through the control port 176.

Pressurized fluid from the supply port 174 is introduced to the pilot control member 182 by a pilot channel 198 that extends generally parallel to the longitudinal bore 168. Pressurized fluid travels through the pilot channel 198 to an input port 200 that allows pressurized fluid be introduced to the pilot control member 182.

The spool 180 can slide in an upward direction relative to FIG. 5 through the use of a feedback circuit. The feedback circuit consists of a feedback chamber 202 located at a second end 172 of the longitudinal bore 168. Pressure is sent to the feedback chamber 202 through a second portion of the feedback circuit called a feedback channel 204 that extends generally parallel to the longitudinal bore 168. The feedback channel 204 extends between the control port 176 and a feedback input port 206 which is an aperture that operatively connects the feedback channel 204 to the feedback chamber 202.

The operation of the valves depicted in FIG. 5 will now be discussed in detail. In FIG. 5 the solenoid 130 is de-energized so that there is no electric current flowing through the magnetic coil 154. The armature 152 is in a relaxed position so that it is resting against a spring 208. The pin valve 156 is press fit or integrally formed with the armature 152 and will slide upward and downward relative to FIG. 5 when the solenoid 130 fluctuates between the energized and de-energized state.

The armature 152 has a portion that overlaps a pole piece 210 that allows for the solenoid 130 to operate in a proportional manner. When the solenoid 130 becomes energized the armature 152 will slide downward relative to FIG. 5 so that the overlap between the armature 152 and the pole piece 210 increases. Additionally, as the armature 152 slides downward the pin valve 156 will also move in the downward direction. The pin valve 156 is stabilized during movement by the front bearing 158 and the rear bearing 160. As the pin valve 156 moves downward the tappet 166 portion of the pin valve 156 presses against the ball 190 of the low-leak bleed valve 188 located in the pilot control member 182. As the ball 190 is moved away from the edge of the cage 192 pressure from the supply port 174 is transmitted via the pilot channel 198 to the input port 200 of the pilot control member 182. When the ball 190 moves away from the edge of the cage 192 pressure at the input port 200 moves past the ball 190 where the pressure will move down the pilot passage 194 into the pilot control chamber 196. As pressure increases in the pilot control chamber 196 the spool 180 will slide downward relative to FIG. 5 so that pressure at the supply port 174 will move into the pressure transition region 212 of the spool 180. Pressurized fluid in the pressure transition region 212 of the spool 180 will then be supplied to the control port 176 where the pressure will flow to the hydraulic clutch 134.

In addition to pressure being supplied to the pilot control chamber 196 when the solenoid 130 is energized, pressure will also move past the pilot exhaust valve seat 184 portion and the pilot control member 182. As pressure moves past the pilot exhaust valve seat 184 it will flow to the exhaust pilot 156. The flow of pressure past the pilot exhaust valve seat 184 will be influenced by the annular shoulder 164 of the pin valve 156. As the annular shoulder 164 moves closer to the pilot exhaust valve seat 184 a throttling action occurs. It is also possible for the annular shoulder 164 to press firmly against the pilot exhaust valve seat 184 in order to completely close off any flow to the exhaust pilot 156.

When the solenoid 130 is de-energized the armature 152 and pin valve 56 will slide upward so that the low-leak bleed valve 188 will be closed as the ball 190 becomes seated at the edge of the cage 192. Pressure in the pilot control chamber 196 and other portions in and around the pilot control member 182 will be relieved through the exhaust pilot 156. As the ball 190 moves to the closed position pressure at the input port 200 will press against the ball 190 which is then transmitted to the tappet 166 that counters the force of the spring 208 pressing against the armature 152. The spring 208 functions to keep the pin valve 156 in the correct position when the solenoid 130 is in its de-energized state. However, the resilience of the spring 108 is low enough that it can be overcome by the pressure of fluid against the ball 190.

In order to facilitate the movement of the spool 80 in an upward direction relative to FIG. 5 once the ball 190 is moved to the closed position, the feedback circuit is implemented. Pressure built up at the control port 176 is transmitted to the feedback chamber 202 via the feedback channel 204 through the input 176. As the pressure builds in the feedback chamber 202 the spool 180 will move in the upward direction to close off and prevent pressure from the supply port from entering the pressure transition region 212. It is also possible to incorporate a spring element (not shown) in the feedback chamber 202 that will also aid in the movement of the spool 180 in an upward direction. As the spool 180 moves to a position where the supply port 174 is closed off from supplying pressure to the pressure transition region 112, pressure built up in the control port 176 and the pressure transition region 212 as well as in the feedback channel 204 will also be relieved through the exhaust port 178. The exhaust port 178 as well as the exhaust pilot 156 lead to a sump where the pressurized fluid will be recirculated back though the vehicle system.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A control valve assembly having a single assembly comprising:
a low-leak pilot bleed valve within said single assembly including a first variable orifice and a second variable orifice in series which open and close in opposition to one another to control an intermediate pilot pressure between said first variable orifice and said second variable orifice and a feedback area on which said pilot pressure acts to create a feedback force;
a solenoid portion within said single assembly operably connected to said low-leak pilot bleed valve to control said intermediate pilot pressure; and
a valve portion within said single assembly that translates said pilot pressure into a regulated output control pressure.

2. The control valve assembly having a single assembly of claim 1, wherein said pilot pressure is regulated by the balance of magnetic force from said solenoid portion and a feedback force from pilot pressure acting on a feedback area of said low-leak pilot bleed valve.

3. The control valve assembly having a single assembly of claim 2, further comprising a solenoid spring within said single assembly acting on said solenoid portion and contributes to the force balance between said magnetic force and said feedback force.

4. The control valve assembly having a single assembly of claim 3, wherein said solenoid spring acts to open first said orifice and close second said orifice to increase said pilot pressure.

5. The control valve assembly having a single assembly of claim 4, wherein increasing current to said solenoid portion increases magnetic force acting in opposition to said solenoid spring to close said first orifice and open said second orifice to decrease said pilot pressure.

6. The control valve assembly having a single assembly of claim 2, wherein increasing current to said solenoid portion increases magnetic force acting to open said first variable orifice and close said second orifice to increase said pilot pressure.

7. The control valve assembly having a single assembly of claim 2, wherein said pilot pressure is communicated to said valve portion within said single assembly.

8. The control valve assembly having a single assembly of claim 1, wherein said output control pressure in said valve portion is regulated by a spool valve which is balanced by said pilot pressure acting on a first area of said spool valve in a first direction and by control pressure acting on a second area of said spool valve in the opposite direction.

9. The control valve assembly having a single assembly of claim 8, further comprising a spool spring, within said single assembly which also contributes to the force balance between said pilot pressure and said control pressure, is included in said valve portion.

10. A control valve having a single assembly comprising:
a low-leak pilot bleed valve within said single assembly including a first variable orifice and a second variable orifice in series which open and close in opposition to one another to control an intermediate pressure between said first variable orifice and said second variable orifice and a feedback area on which said pilot pressure acts to create a feedback force;
a solenoid portion within said single assembly operably connected to said low leak pilot bleed valve to control said intermediate pilot pressure;
a valve portion within said single assembly that translates said pilot pressure into a regulated output control pressure; and
a solenoid spring within said single assembly acting on said solenoid portion to open said first variable orifice and close said second variable orifice to increase said pilot pressure.

11. The control valve assembly having a single assembly of claim 10 wherein said output control pressure in said valve portion is regulated by a spool valve which is balanced by said pilot pressure acting on a first area of said spool valve and a first direction and by control pressure acting on a second area of said spool valve in the opposite direction.

12. The control valve assembly having a single assembly of claim 11 further comprising a spool spring, within said single assembly which also contributes to the force balance between said pilot pressure and said control pressure, is included in said valve portion.

13. A control valve having a single assembly comprising:
a low-leak pilot bleed valve within said single assembly including a first variable orifice and a second variable orifice in series which open and close in opposition to one another to control an intermediate pilot pressure between said first variable orifice and said second variable orifice and a feedback area on which said pilot pressure acts to create a feedback force;
a solenoid portion within said single assembly operably connected to said low-leak pilot bleed valve to control said intermediate pilot pressure;
a valve portion within said single assembly that translates said pilot pressure into a regulated output control pressure, wherein said valve portion includes a spool valve which is balanced by said pilot pressure acting on a first area of said spool valve in a first direction and by control pressure acting on a second area of said spool valve in the opposite direction.

14. The control valve assembly having a single assembly of claim 13, wherein said pilot pressure is regulated by the balance of magnetic force from said solenoid portion and a feedback force from pilot pressure acting on a feedback area of said low-leak pilot bleed valve.

15. The control valve assembly having a single assembly of claim 14 wherein increasing current to said solenoid portion increases magnetic force to open said first variable orifice and close said second variable orifice to increase said pilot pressure.

16. The control valve assembly having a single assembly of claim 13, wherein said pilot pressure is communicated to said valve portion within said single assembly.

17. The control valve assembly having a single assembly of claim 13 further comprising a solenoid spring within said single assembly acting on said solenoid portion and contributes to the force balance between said magnetic force and said feedback force.

18. The control valve assembly having a single assembly of claim 17 wherein said solenoid spring acts to close said first variable orifice and open said second variable orifice to increase said pilot pressure.

19. The control valve assembly having a single assembly of claim 17 wherein said solenoid spring acts to open said first variable orifice and close said second variable orifice to increase said pilot pressure.

20. The control valve assembly having a single assembly of claim 19 wherein increasing current to said solenoid portion increases the magnetic force acting in opposition to said solenoid spring to close said first orifice and open said second orifice to decrease said pilot pressure.
